(19) United States
(12) Patent Application Publication
(10) Pub. No.: US 2006/0037460 A1
(43) Pub. Date: Feb. 23, 2006

(54) Mathematical fret placement system and method

(76) Inventor: Jorge R. Salazar, South Ozone Park, NY (US)

Correspondence Address: WILLIAM COLLARD;COLLARD & ROE, P.C., 1077 NORTHERN BOULEVARD, ROSLYN, NY, 11576, US

(21) Appl. No.: 10/964,901

(22) Filed: Oct. 14, 2004

Related U.S. Application Data
(60) Provisional application No. 60/522,152, filed on Aug. 21, 2004.

(51) Int. Cl. G10D 3/06; G10D 1/08; G10D 3/04

(52) U.S. Cl. 84/314 R

(57) ABSTRACT

A method of positioning a set of frets on a musical instrument. This method comprises dividing a fretboard of the musical instrument into a plurality of units, and then dividing these plurality of units into a series of groups. Next, these groups can be divided into sub-groups to form intervals. Next musical pitches or frets can be positioned for the musical instrument wherein these pitches are further sub-groups of the intervals of these units. In one embodiment, these units can be in the form of 360 equally divided units. In another embodiment, these units can be in the form of 648 units of 1 mm in length. A set of predetermined spacing relationships can then be used to create the spacing distances and the positions of the frets on a fretboard.

### CROSS REFERENCE TO RELATED APPLICATIONS

The applicant hereby claims priority under 35 U.S.C. 119(e) from provisional application Ser. No. 60/511,152 filed on Aug. 21, 2004 the disclosure of which is hereby incorporated herein by reference.

### BACKGROUND

The invention relates to a system and method for the placement of frets on a fretboard. This system and method includes a measurement system for setting these frets in a particular geometric range to achieve a particular result. This relationship results in a perfect intonation upon the chromatic scale. The chromatic scale is a 12-note scale including all the semitones of the octave. For a tempered chromatic scale, this involves using a constant frequency multiple between the notes of the chromatic scale. Other systems and methods for placing frets on a fretboard have been known such as in U.S. Pat. No. 5,063,818 to Jorge Salazar issued on Nov. 12, 1991, and incorporated herein by reference.

For example, in the past, fret positioning on a stringed instrument has been laid out via a traditional formula such as the rule of eighteenth. In this case, the vibrating string lengths such as the distance from the bridge to the guitar nut is divided by eighteen. This is done to locate the position of the first fret which is spaced from the nut. Then, the remaining string length, such as the distance of the first fret to the bridge is again divided by eighteen to locate the position of the second fret. This formula is then repeated until all of these frets are placed on the fingerboard. This rule of eighteenth is only an approximating method for determining this fret placement and therefore does not result a perfect pitch for the tones produced when a string is engaged with a fret wherein the remaining length is vibrated.

Alternatively, another method is the whole tone scale, wherein this whole tone scale is the distance from the nut to the bridge wherein this distance is divided by 9 to locate the first whole tone fret. Similar to the rule of eighteen or eighteenth, this formula involves dividing the remaining string length by 9 wherein these steps are repeated until all of the frets for producing these whole tones are placed on the fingerboard. This whole tone suffers from the same deficiency in that this fret placement does not result in perfect whole tones when the strings are vibrated. Thus, there is still a need for fingerboard construction which can achieve perfect pitch for the tones produced when a string is engaged with a given fret, while the remaining string length is vibrated.

### SUMMARY

The invention relates to a system and method for allowing fretted and stringed instruments such as a guitar to produce perfect intonation throughout an entire fretboard. This system and method can essentially create a perfect pitch for a guitar wherein perfect pitch means that the intervals between members of any chromatic major, minor, or any kind of scale should have a proper vibrational relationship. For example, a relation between a high G to a high C must have the same number of vibrations as a high C to a double G.

This system and process starts as follows: first the whole scale length from the nut to the bridge should be divided into a set of equal units. Next the scale length can be divided into equal parts or groups each comprising a plurality of these units. For example, if a guitar scale length is first divided into 360 units of equal length, the scale could be divided up into four parts of 90 units each or by the following formula 360/4=90. In many cases, a standard guitar fretboard length could be 648 millimeters which can be divided into 360 discrete units each of 1.8 millimeters in length. Thus, the relational units are determined, and then after proceeding through the entire analysis, these units are multiplied by the scalar difference such as 1.8 to determine the length in millimeters between each of the frets on a fretboard.

For this process, each group, sub-group, interval or fret is considered to have a “length” which is the distance that is spaced from the next adjacent group, sub-group, interval or fret that is nearest to the nut. Next, each of these groups is divided into sub-groups to form intervals. In each of these groups there can be two types of intervals, a first major second interval and a first minor third interval. For example, in the first group the first major second interval is ⅘ in length of the first minor third interval. Thus, in this next step, this first quarter part is divided up into nine additional parts or by 90/9=10. From this subsection, four parts of this result would then belong in the first major second interval which would be 4×10=40.

A major second interval is composed of two half pitches. These two half pitches represent fret placements.

The first minor third interval occupies the remaining area of this first quarter distance of the desired length. This distance of the first minor third interval includes the third, fourth, and fifth pitches, or respectively the third, fourth, and fifth frets. Thus, these three frets occupy the remaining distance of 50 (90−40) parts. The placement of these three frets is determined by a particular pattern. First, the spacing distance of the fifth fret from the fourth fret is determined based upon a relational basis to the length of the third fret and it also relates in distance to the length of the second fret. In all instances, the fifth fret is on a ⅘ spacing distance ratio to the spacing distance of the second fret and a ⅞ spacing distance ratio to the third fret.

To determine the position of all of these frets, first, the length or spacing distance of the fourth fret from the third fret is determined to be ⅓ of the length of the first minor third. Thus, in this case, this distance is calculated using the formula 50/3=16.66667 units. To determine the lengths of the spacing distances of the remaining frets 1, 2, 3, and 5, a series of length relationships are used. These length relationships include the length of the spacing distance fifth fret from the fourth fret which is ⅘ of the length of the second fret, and ⅞ the length of the third fret. Therefore, the length of the third fret can be determined using the following formula:
x+⅞x=⅔*50

wherein x=the length of the third fret.

(x=17.7778 units)

Once the length of the spacing of the third fret from the second fret has been determined, since the length of the spacing of the fifth fret from the fourth fret is ⅞ of the spacing of the third fret from the second fret, the spacing of the fifth fret from the fourth fret is then 15.5556. In addition, the length or spacing of the second fret from the first fret can be determined from the above assumptions so that this spacing of the second fret is 5/4*15.5556=19.44445 units.

Once this second fret spacing length has been determined as 19.4445 units, since this first major second interval length from the nut is a total of 40 units, and the lengths of the first fret from the nut and the second fret from the first fret equal 40 units, the length or distance of the first fret from the nut would be 40−19.4445 or 20.5555 units.

In the next stage, the next quarter sized region or group includes the sixth through twelfth frets which total 90 units. This region can be calculated taking into account the other related regions. For example, for the spacing distances of the 6^{th}, 7^{th,} 8^{th}, 9^{th}, 10^{th} frets from their adjacent frets, these distances are exactly ¾ths of the length of the spacing distances of the 1^{st}, 2^{nd}, 3^{rd}, 4^{th}, and 5^{th} frets respectively. Next, the spacing distances of the 11^{th} and 12^{th} frets are exactly ¾ths of the length of the spacing distances of the 6^{th} and 7^{th} frets respectively.

Thus, these frets 6-12, comprise the entire distance of the second quarter unit or group. Once these frets have been determined, the third quarter group can also be determined. The third quarter group essentially comprises 12 frets wherein the spacing distances of each of these frets 13-24 are exactly ½ of the length of the spacing distances of the previous 12 frets respectively. Finally, the 4^{th} quarter group or region can optionally include additional frets, however, in many cases, no additional frets are included in this fourth region. Once these different fret distances and placements have been configured, on this unit scale, they can be scaled up to different distances depending on the desired length.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a plan view of a guitar being divided into different groups;

FIG. 2 is a plan view of a section of the guitar in FIG. 1 showing the fret board layout; and

FIG. 3 is a schematic block diagram presenting an overview of the process for a mathematical system for creating spacing of frets on a guitar.

### DETAILED DESCRIPTION

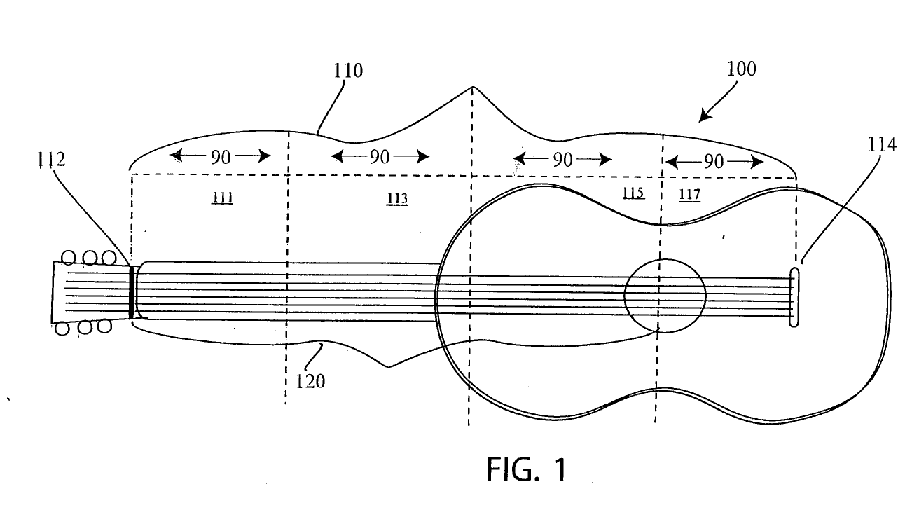

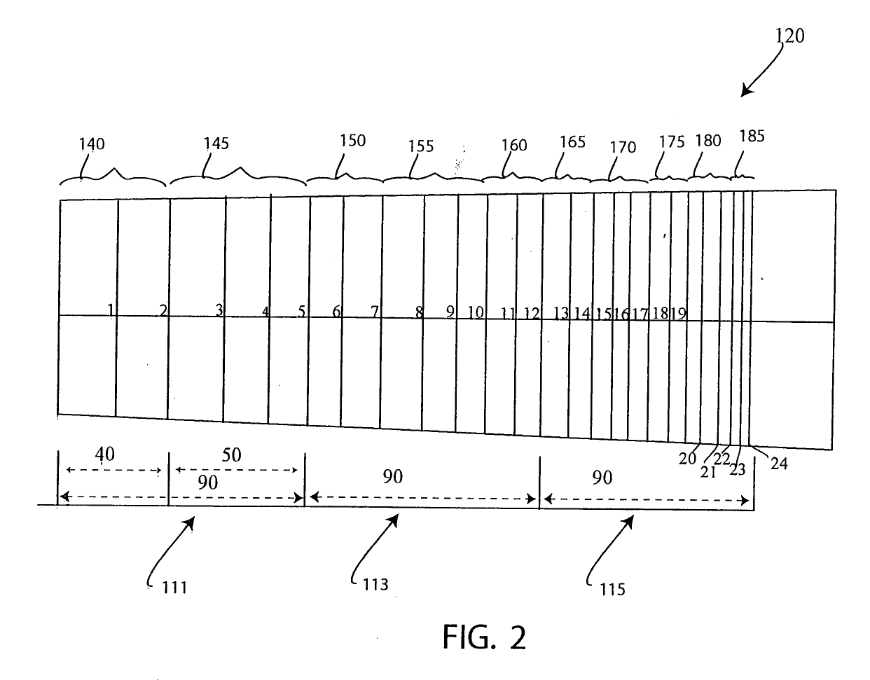

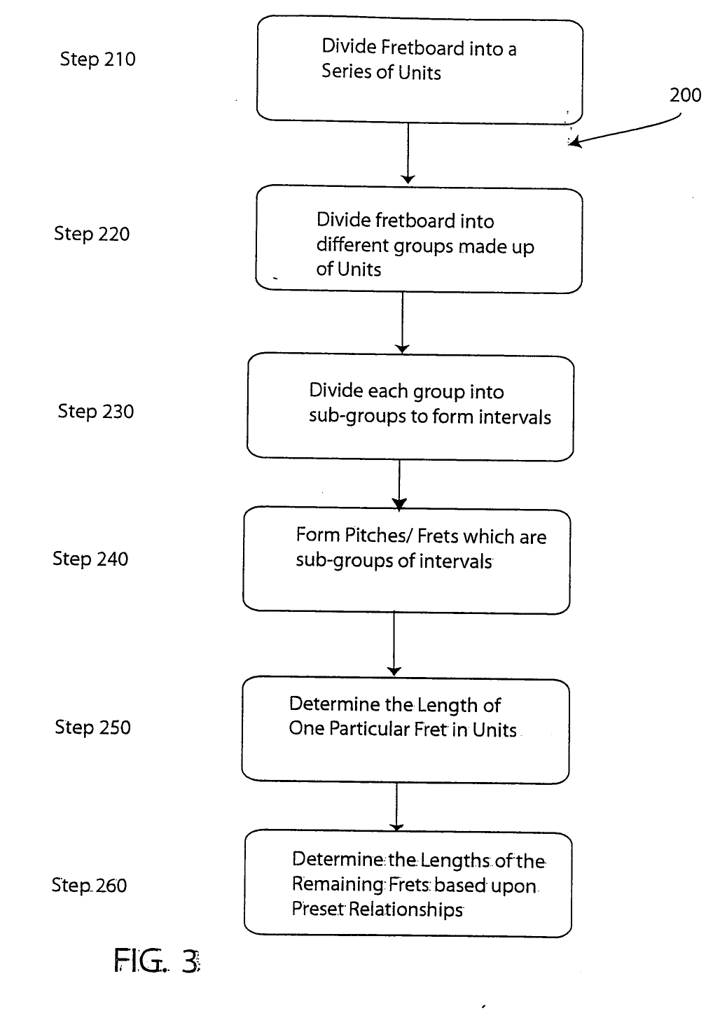

Referring in detail to the drawings, FIG. 1 shows for example, a guitar 100, wherein the open string length 110, which is the length between nut 112 and bridge 114, can be divided into a set of discrete units as shown by step 210 in FIG. 3. In one embodiment, this length can be divided into a set of 360 units of equal length. Next, in step 220 this whole length is divided into four separate parts of groups 111, 113, 115, and 117 (See FIG. 2) of 90 units each so that these parts are formed by the formula 360/4=90. Therefore, each part of the fretboard would include 90 separate units. Each of these four parts 111, 113, 115, and 117 is then divided into sub-parts in step 230 to form intervals (See also FIG. 2). From the basic knowledge of music, the first major second interval 140 and the first minor third interval 145 compose the first two of these separate intervals. In addition, the ratio of the length of first major second interval 140 to first minor third interval 145 is 4:5. Therefore, the first major second interval 140 would comprise 40 units and the first minor third interval 145 would comprise 50 units to create the total 90 units.

Once the interval lengths have been determined, the frets must be placed into these first intervals in step 240.

This process is performed using the following assumptions:

1) the first interval, that of the first major second includes two (2) frets, while the second interval, that of the first minor third includes three frets, totaling the first five frets 1, 2, 3, 4, 5;

2) the fourth fret 4 is ⅓ of the length of the second minor third interval;

3) the fifth fret 5 is ⅘ of the length of the second fret 2 and ⅞ the length of the third fret 3.

Using these assumptions, the length or distance spacing between each of these five frets can be determined using the mathematical relationships in these assumptions.

Given that the length or spacing of the first minor third interval in the first group is 50 units, the length of the spacing of the fourth fret from the third fret can be easily determined as 50/3 or 16.6667 units.

In step 250, using these relationships, the length or distance of spacing of the third fret from the second fret can be determined using the formula below:
x+⅞x=2/3*50 (units)

wherein x=the length of the third fret.

Solving for x, x=17.7778 units.

As disclosed in step 260, once the length or spacing of the third fret from the second fret has been determined, since the length of the fifth fret is ⅞ of the third fret, the length of the fifth fret is then 15.5556. In addition, the length of spacing of the second fret from the first fret can be determined from the above assumptions so that the length of spacing of the second fret is 5/4*15.5556=19.4444 units.

Once this second distance has been determined as 19.4444 units, since the first major second length is a total of 40 units, and the lengths of the first fret and the second fret equal 40 units, the length or distance that the first fret is spaced from the nut would be 40−19.4445 or 20.5555 units.

Now the lengths of spacing of the first five frets have been determined as: 1) 20.5555; 2) 19.4445; 3) 17.7778; 4) 16.6667; and 5) 15.5555 units. The position and spacing of the frets in the next quarter group of 90 units can also be determined based upon a set of additional assumptions.

For example, this next quarter, or second quarter 113 of 90 units includes one first major second interval comprising two frets, one first minor third interval comprising three frets, and an additional first major second interval comprising two frets. These additional frets are numbered 6, 7, 8, 9, 10, 11 and 12 respectively.

Next, the retrospective length of spacing of the next five frets, that of frets 6, 7, 8, 9, and 10 are ¾ of the respective lengths or spacing of frets 1, 2, 3, 4, and 5. Therefore, the unit lengths of the spacing of these frets 6-10 are as follows: 6) 15.4167; 7) 14.583; 8) 13.3334; 9) 12.5556; and 10) 11.6667.

Next, the lengths of the spacing of the two remaining frets 11 and 12 in this second quarter group can also be calculated. These fret lengths or spacings of frets 11 and 12 are ¾ of the length of the spacing of frets 6 and 7 respectively. Therefore, the lengths in units of the spacing of these frets are: 11) 11.5625; and 12) 10.9375.

The third quarter group 115 includes a total of twelve frets numbered 13-24 wherein these twelve frets fit into an entire length of 90 units. The lengths of the spacing of each of these frets 13-24 from the next adjacent fret closer to the nut, corresponds to ½ of the length of the spacing of frets 1-12 respectively. Therefore, the lengths of the spacing of frets 13-24 in units are as follows: 13) 10.2778; 14) 9.7772; 15) 8.8889; 16) 8.3335; 17) 7.7778; 18) 7.70835; 19) 7.29165; 20) 6.66665; 21) 6.25; 22) 5.8335; 23) 5.7812; and 24) 5.4687.

The final quarter length of 90 units can remain open for strumming given the existence of 24 frets which can be used by the guitar player.

This unit system of 360 units can then be scaled up to a set of different lengths so that if a guitar has an open string length of 648 mm, the 360 unit system can be scaled up to 648 by multiplying the above unit lengths by a factor of 1.8 to determine the proportionate fret placement in millimeters.

As described above, while 360 units was selected, this number can be changed to fit a user's needs. However, since the relationships and methodology for determining fret lengths has been determined, regardless of the type of units used, these frets will always be placed in proportion to each other on the fretboard.

Accordingly, while at least one embodiment of the present invention has been shown and described, it is to be understood that many changes and modifications may be made thereunto without departing from the spirit and scope of the invention as defined in the appended claims.

What is claimed is:

1. A method of positioning frets on a fretboard of a stringed musical instrument, the method comprising:
a) dividing a whole scale length into a series of units;
b) dividing the whole scale length into a plurality of groups of substantially equal length made up of said units;
c) dividing each group of said plurality of groups into a plurality of sub groups to form intervals;
d) determining a length of spacing of at least one fret in said units;
e) determining a position of at least one fret which is disposed in said intervals;
f) determining a length of spacing and a position of the remaining frets based upon preset spacing relationships between the frets; and
g) placing the frets on said fretboard.

2. The method as in claim 1, wherein said step of dividing each of said plurality of groups into a plurality of sub groups involves forming at least two intervals including at least a first interval and at least a second interval.

3. The method as in claim 2, wherein said step of determining a length of spacing of said at least one fret on the fretboard includes the step of determining a length of spacing of a fourth fret on the fretboard to be ⅓ of the length of said second interval.

4. The method as in claim 1, wherein said step of dividing said fretboard into a series of units involves dividing said fretboard into 360 units of equal length.

5. The method as in claim 1, further comprising the step of translating said units into units of different length by multiplying a set of lengths of said frets by a set scale to provide a new position for each of said frets.

6. The method as in claim 1, wherein said step of dividing said fretboard into different groups involves dividing said fretboard into four separate groups, each group being of equal length.

7. The method as in claim 6, wherein said step of dividing said plurality of groups into a plurality of sub-groups involves dividing said each of said plurality of groups into different intervals including at least two intervals including at least a first interval and a second interval wherein said first interval is positioned adjacent to a nut on a guitar and said second interval is positioned adjacent to said first interval.

8. The method as in claim 7, wherein said step of determining a position of said at least one fret includes determining that at least three frets are disposed in said second interval.

9. The method as in claim 8, wherein said step of determining a length of spacing of said at least one fret involves determining a length of spacing of said at least one fret in said second interval.

10. The method as in claim 9, wherein said step of determining a length of spacing and a position of said remaining frets involves first determining a length of spacing and then a position of each of said remaining frets in said second interval, and then determining a length of spacing and position of remaining frets in other intervals.

11. The method as in claim 10, wherein said step of determining a length of spacing and position of said remaining frets involves determining a length of spacing of said remaining frets in said first interval after determining a length of spacing of said remaining frets in said second interval.

12. The method as in claim 11, wherein said step of determining a length of spacing and a position of said remaining frets involves determining a length of spacing of said remaining frets in a third interval after determining a length of spacing of said remaining frets in said second interval.

13. The method as in claim 12, wherein said step of determining said length of spacing and position of said remaining frets includes determining a length of spacing of said frets in said third and fourth intervals as being ¾ of a length of spacing of said first five frets in said first and said second intervals.

14. The method as in claim 13, wherein said step of determining a length of spacing and position of said remaining frets includes determining a length of spacing and position of said remaining frets in said fifth interval as being ¾ of the length of spacing of the frets in said third interval.

15. The method as in claim 14, wherein said step of determining a length of spacing and position of said remaining frets includes determining a length of spacing and position of at least twelve frets in said third group on a ratio of ½ of a length of spacing of said first twelve frets.

16. The method as in claim 7, wherein said first interval includes two frets, a first fret, and a second fret, and wherein said second interval includes three frets including a third fret, a fourth fret, and a fifth fret, wherein said step of determining a length of spacing of said at least one fret includes determining a length of spacing of said fourth fret to be ⅓ of the length of spacing of said the second interval.

17. The method as in claim 7, wherein said step of determining a length of spacing and position of said remaining frets includes determining a length of spacing of said third fret, based upon a ratio of a length of spacing of said third fret from said second fret to said length of spacing of said fifth fret from said fourth fret, and then determining a position of said third fret as the length of said third fret from an end position of said first interval while a position of said fourth fret is a distance from said position of said third fret.
